(19) United States
(12) Patent Application Publication
(10) Pub. No.: US 2018/0011789 A1
(43) Pub. Date: Jan. 11, 2018

(54) REDUCING IDLE RESOURCE USAGE

(71) Applicant: INTERNATIONAL BUSINESS MACHINES CORPORATION, Armonk, NY (US)

(72) Inventors: Michael H. Dawson, Ottawa (CA); Gireesh Punathil, Kuthuparamba (IN)

(21) Appl. No.: 15/667,831

(22) Filed: Aug. 3, 2017

Related U.S. Application Data
(63) Continuation of application No. 15/205,443, filed on Jul. 8, 2016.

(51) Int. Cl. G06F 12/02

(52) U.S. Cl. CPC G06F 12/0261; G06F 2212/1041; G06F 2212/154

(57) ABSTRACT

A method, computer program product, and system for reallocating resources of an idle application or program includes a computer for running an application or a program and starting a predetermined time interval. The computer increases a number counter for each event triggered during the predetermined time interval, and the event is a predetermined trigger that is activated during the running of the application or program. The method and system includes comparing a total number of events that occur during the predetermined time interval to a threshold value. The total number of events is the value of the number counter at the end of the predetermined interval. In response to determining, by the computer, the total number of events being below the threshold value, releasing resources allocated to the program by activating, using the computer, either: i) a garbage collector application, or ii) a resource release application.

### BACKGROUND

The present invention relates generally to the field of computer memory regarding accessing computer memory and resources, and more particularly to reallocation of computer memory and resources being used by idle programs/applications.

Garbage collection (GC) is a form of automatic memory management. The garbage collector attempts to reclaim garbage, or memory occupied by objects that are no longer in use by a program or application. GC is often portrayed as the opposite of manual memory management, which requires the programmer to specify which objects to deallocate and return to the memory system. GC may take a significant proportion of total processing time in a program and, as a result, can have significant influence on performance.

Runtimes that use GC are can work best when removing garbage when there is a lot of activity and GC resources are near the maximum limits. However, in cases where an application or program has gone idle they may leave the heap (an area of memory from which objects are allocated) in a state that contains garbage that could be collected, but may not be collected because there is no activity and/or need for additional resources. Similarly, other resources, for example, memory buffers, may not be released during a period of inactivity.

### BRIEF SUMMARY

Additional aspects and/or advantages are set forth in the description which follows and are apparent from the description, or may be learned by practice of the invention.

Embodiments of the present invention disclose a method, computer program product, and system for reallocating resource of an idle application or program. The computer runs an application or a program and starts a predetermined time interval. The computer increases a number counter for each event triggered during the predetermined time interval. The event is a predetermined trigger that is activated during the running of the application or program. A total number of events that occurred during the predetermined time interval is compared to a threshold value, wherein the total number of events is the value of the number counter at the end of the predetermined interval. In response to determining, by the computer, the total number of events being below the threshold value, releasing resources allocated to the program by activating, using the computer, either: i) a garbage collector application, or ii) a resource release application.

### BRIEF DESCRIPTION OF THE DRAWINGS

The above and other aspects, features, and advantages of certain exemplary embodiments of the present invention will be more apparent from the following description taken in conjunction with the accompanying drawings.

FIG. 1 is a functional block diagram illustrating a data processing system for reallocation of resources, in accordance with an embodiment of the present invention.

FIG. 2 is a flowchart depicting operational steps for reallocation of resources within the data processing system of FIG. 1, in accordance with an embodiment of the present invention.

FIG. 3 is a flowchart depicting operational steps for number of events of an application within the data processing system of FIG. 1, in accordance with an embodiment of the present invention.

FIG. 4 is a block diagram of components of a computing device of the data processing system for reallocation of resources of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for reallocating resources used by an idle application or program. An idle determination technique using runtimes includes using an event loop to schedule work (for example, a Node) that identifies an idle application and then reduces heap usage by proactively triggering garbage collections (GC) and/or other resource release processes. The technique reduces pressure on the cloud infrastructure so that less memory needs to be swapped out, increasing the chance that when an application wakes up the areas of memory that are needed to progress don't need to be swapped in. An interval is started, i.e. a predetermined time period, where the number of events for an application or program are counted. The events can be any type of trigger in run time of the application/program. The number of events are counted during the interval and compared to a to determine if the application/program is idle and to determine if the garbage collector (GC) needs to be run to release resources or determine if the resource should be released without running the GC.

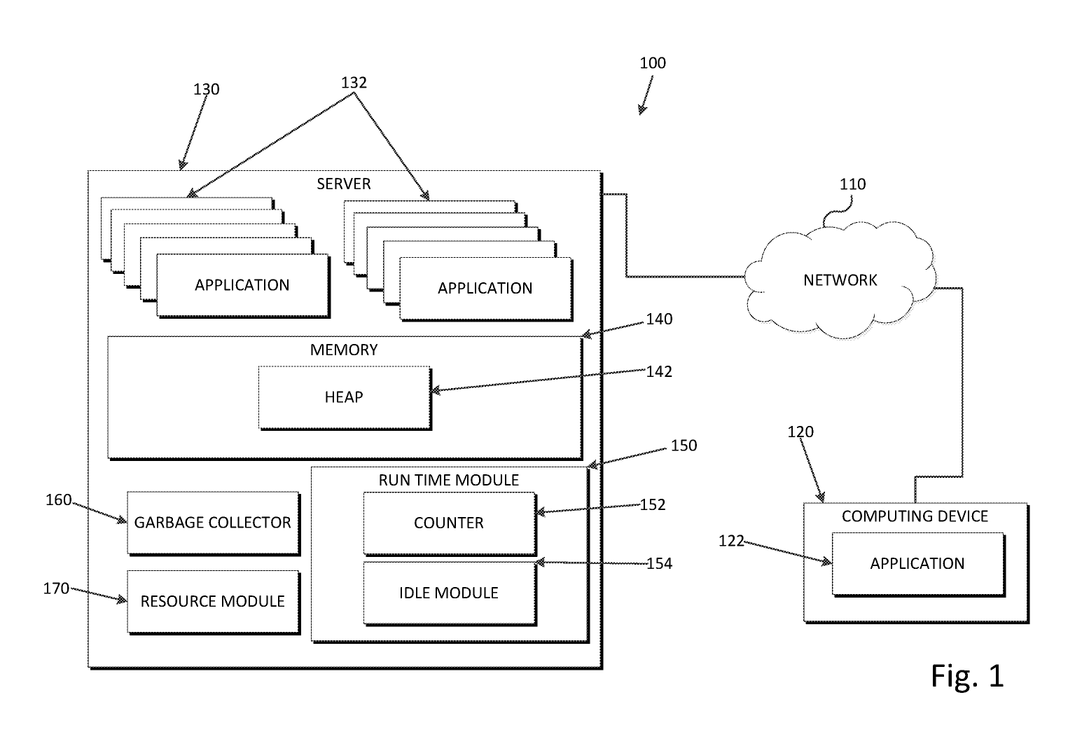

FIG. 1 is a functional block diagram illustrating a data processing system 100 for reallocation of resources, in accordance with an embodiment of the present invention. The data processing system 100 includes a computing device 120 and a server 130 that communicate via network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between the computing device 120, and server 130, in accordance with one or more embodiments of the invention.

The computing devices 120 represents a computing device that includes a user interface, for example, a graphical user interface part of an application 122. The application 122 can be any type of application that is run on the server 130, for example, the application can be an email application, a graphical application, an editing application or any other type of application/program.

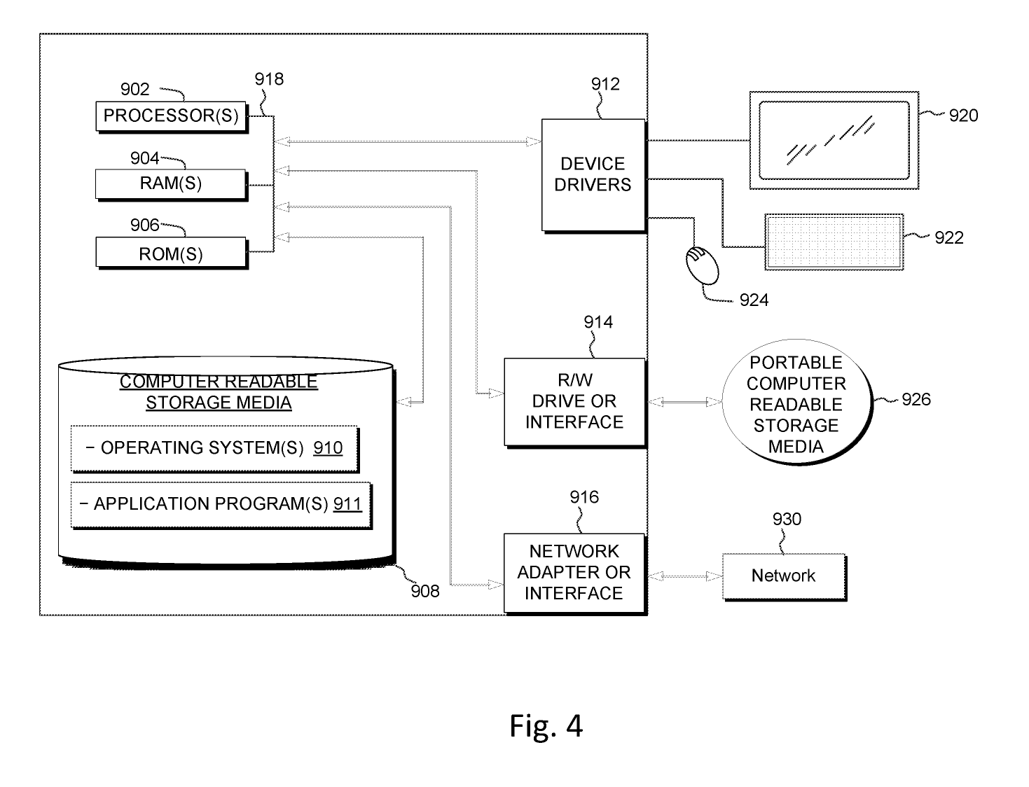

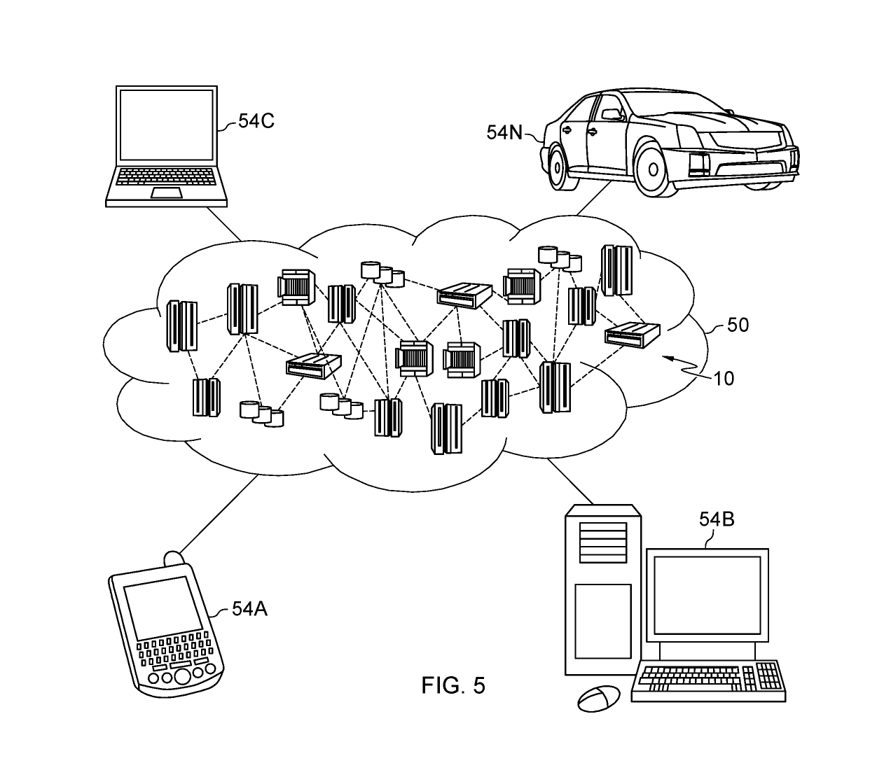

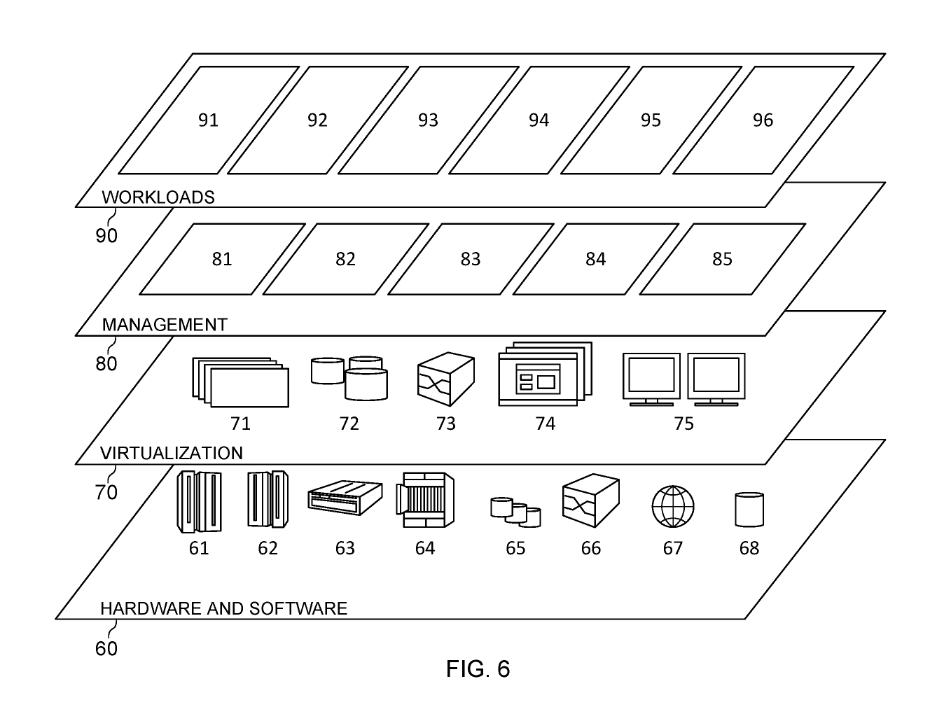

The computing device 120 may be any type of computing devices that are capable of connecting to network 110, for example, a laptop computer, tablet computer, netbook computer, personal computer (PC), a desktop computer, a smart phone, or any programmable electronic device supporting the functionality required by one or more embodiments of the invention. The computing device 120 may include internal and external hardware components, as described in further detail below with respect to FIG. 4. In other embodiments, the server 130 may operate in a cloud computing environment, as described in further detail below with respect to FIGS. 5 and 6.

The server 130 runs or operates a plurality of applications 132 that the computing device 120 is able to access. The server 130 includes the applications 132, memory 140, run time module 150, garbage collector 160 and a resource module 170. The application 132 can be a single application, a plurality of different applications, a plurality of the same application running for different computing devices 120, or any combination thereof. Server 130 may include internal and external hardware components, as depicted and described in further detail below with reference to FIG. 4. In other embodiments, computing device 120 may include internal and external hardware components, as depicted and described in further detail below with respect to FIG. 5, and operate in a cloud computing environment, as depicted in FIG. 6.

The memory 140 is computer readable storage medium can be a tangible device that can retain and store instructions for use by application 132. The memory 140 may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. The memory 140, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The memory 140 further includes a heap 142. The heap 142 is an area of the memory 140 from which objects are allocated, for example, the different resources for the application 132 may be allocated within the heap 142.

Run time module 150 monitors the applications 132 and determines if the applications 132 are idle or not. The run time module 150 includes a counter 152 and an idle module 154. The counter 152 increases a counter when an event is triggered over a time interval or an event loop during the run time of the application 132. Applications 132 can be an event driven applications that use an “event loop” to process asynchronous events. As application 132 executes, events are added to the event loop along with a callback to be invoked when the event occurs. The event loop is the thread of execution which polls/or waits for notifications that events have occurred and then invokes the associated callback. For example when a request to read a file is execute by the program, a read available event could be added to the event loop. The application 132 then continues to execute until at some point later when the data is available the event triggers and the associated callback is run. The idle module 154 receives the final or total count data for the time interval or event loop to determine if the application 132 is idle or not.

Idle module 154 determines if the application 132 is idle or not by comparing the total counted number of events to a threshold value and if the number of events is below the threshold value then the idle module 154 determines that the application 132 is idle. When the idle module 154 determines if the application 132 is idle, then the idle module 154 determines what the status of the application 132 and changes the status, if needed, to reflect the idle status. The idle module 154 determines if the garbage collector 160 and/or resource module 170 should be active to release the resources allocated to the application 132.

The garbage collector 160 releases objects which are no longer required by the application 132 as they are no longer “reachable” from the program. The garbage collector 160 releases resources from the heap 142, which is the region of memory 140 where objects are stored and that the garbage collector 160 manages by freeing objects when they are no longer required, as well as potentially moving objects to optimize their layout within the heap 142. The garbage collector 160 release the resources so that the heap 142 has the space that the resource occupied become available. This allows the heap 142 to allocate new objects and the number of physical memory pages backing the heap 142 may be able to be reduced, allowing other process to use those physical pages. The resource module 170 is able to release other objects (garbage) that can be released from the heap 142, which are not released by the garbage collector 160.

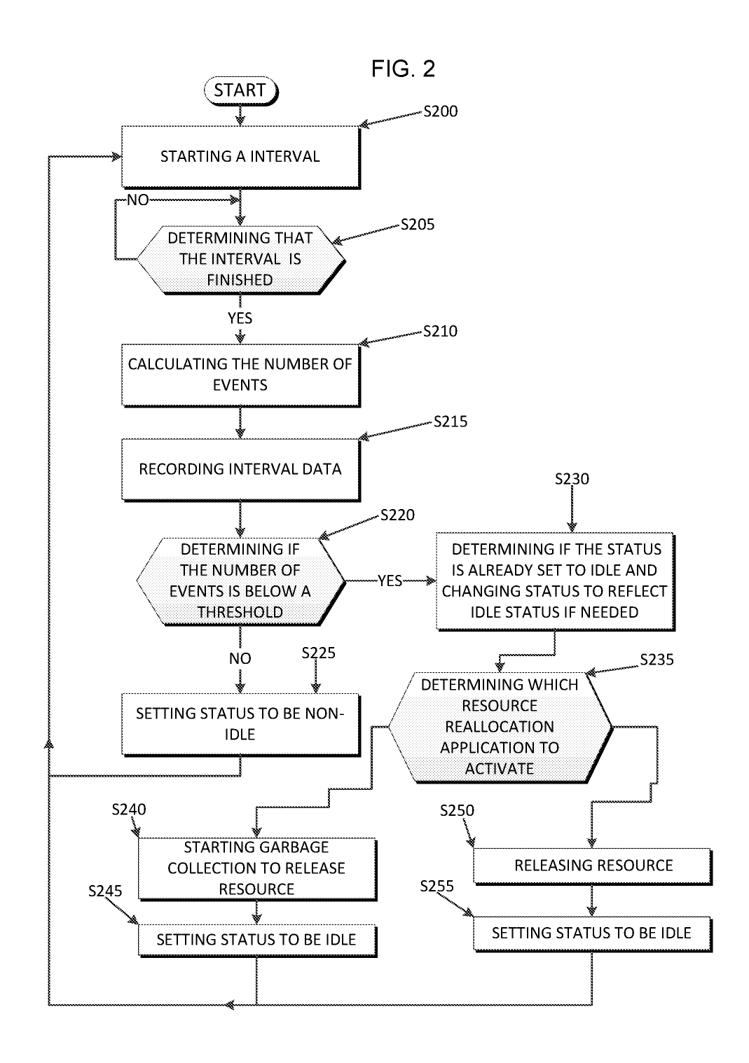

FIG. 2 is a flowchart depicting operational steps for reallocation of resources within the data processing system of FIG. 1, in accordance with an embodiment of the present invention.

An application 132 is running on server 130 that requires resources which have been allocated to a heap 142 in the memory 140. The run time module 150 starts an interval, which is a predetermined time period or time interval, in which the counter 152 counts the number of events or triggered events that occurs during the interval (S200). The counter 152 determines if the interval has finished (S205) and calculated the total number of events that occurred during the interval (S210). The counter 152 sends the total number of events to the idle module 154 to be recorded (S215) and the idle module 154 determines if the number of events is below a threshold value (S220). When the idle module 154 determines that the number of events is above the threshold value then the idle module 154 set the status of application 132 as active and starts the interval period over again (S225).

When the idle module 154 determines that the number of events is below the threshold value, the idle module 154 determines what the current status of the application 132 is (S230). The idle module 154 determines if the garbage collector 160 and/or if the resource module 170 should be activated to release the resources allocated to the application 132 (S235). The garbage collector 160 activates and releases resources from the heap 142 (S240) and the idle module 154 changes the status of the application 132 to idle if a change of status is needed and starts the interval period over again (S245).

The idle module 154 determines if the garbage collector 160 and/or if the resource module 170 should be activated to release the resources allocated to the application 132 (S235). The resource module 170 activates and releases resources from the heap 142 that are not available to be released by the garbage collector 160 (S250) and the idle module 154 changes the status of the application 132 to idle if a change of status is needed and starts the interval period over again (S255).

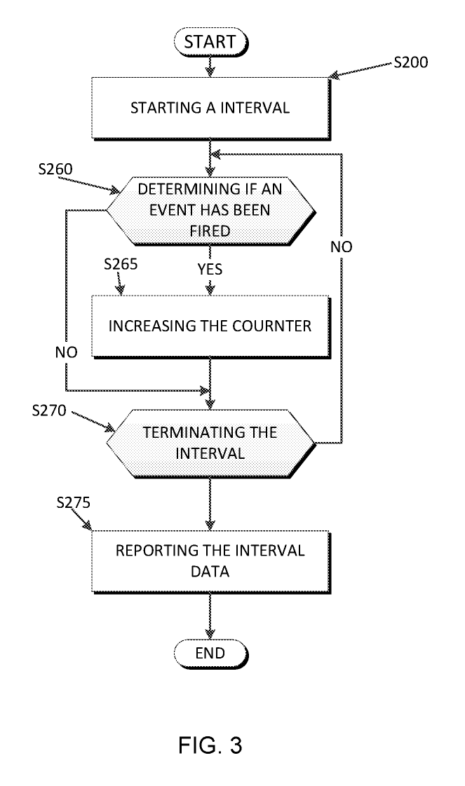

FIG. 3 is a flowchart depicting operational steps for number of events of an application within the data processing system of FIG. 1, in accordance with an embodiment of the present invention.

An application 132 is running on server 130 that requires resources which have been allocated to a heap 142 in the memory 140. The run time module 150 starts an interval, which is a predetermined time period or time interval, in which the counter 152 counts the number of events or triggered events that occurs during the interval (S200). The run time module 150 determines if an event has been fired or triggered (S260). If no event has been triggered, then the run time module 150 determines if the interval is over (S270). When an event is fired or triggered, then the counter 152 increases the count for the current interval (S265). The run time module 150 determines if the interval is over (S270), and when the interval is over, the counter 152 reports or transmit the count for the interval to the idle module 154 (S275).

FIG. 4 depicts a block diagram of components of server 130 of the data processing system of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The computing device 120 and/or server 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, run time module 150 and garbage collector 160 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computer device 120 and/or server 130 may also include a R/W drive or interface 914 to read from and write to one or more portable computer readable storage media 926. Application programs 911 on computing device 120 and/or server 130 may be stored on one or more of the portable computer readable storage media 926, read via the respective R/W drive or interface 914 and loaded into the respective computer readable storage media 908.

Computing devices 120 and/or server 130 may also include a network adapter or interface 916, such as a TCP/IP adapter card or wireless communication adapter (such as a 4G wireless communication adapter using OFDMA technology). Application programs 911 on computing devices 120 and/or server 130 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing devices 120 and/or server 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data processing 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method, comprising:
monitoring, using a computer, a program running on the computer, the monitoring including initiating a predetermined time interval;
increasing, by the computer, a number counter for each of a plurality of events triggered during the predetermined time interval, the events include a predetermined trigger being activated during the running of the program;
comparing, by the computer, a total number of completed events during the predetermined time interval to a threshold value, the total number of completed events being the value of the number counter at an end of the predetermined time interval; and
in response to determining, by the computer, the total number of events being below the threshold value, releasing resources allocated to the program by activating, using the computer, a garbage collector application, wherein the garbage collector application releases objects stored on a heap that are no longer required by the application, thus releasing of the object causes the heap to have free space for allocating new object, wherein the garbage collector application moving objects stored on the heap to optimize their layout within the heap; and
in response to determining, by the computer, the total number of events being below the threshold value, releasing resources allocated to the program by activating, using the computer, a resource release application, wherein the resource release application releases resources that are not released by the garbage collector application.
